(19) United States
(12) Patent Application Publication
(10) Pub. No.: US 2025/0187204 A1
(43) Pub. Date: Jun. 12, 2025

(54) GRIPPER, IN PARTICULAR FOR APPLYING A HONEYCOMB-SHAPED ELEMENT TO A TARGET SURFACE, AND MACHINE PROVIDED WITH SUCH A GRIPPER

(71) Applicant: SAFRAN NACELLES, GONFREVILLE-L'ORCHER (FR)

(72) Inventors: Renaud VENTURE, MOISSY-CRAMAYEL (FR); Benjamin PROVOST, MOISSY-CRAMAYEL (FR); Clément ROLLAND, MOISSY-CRAMAYEL (FR); Maxime LEBEGUE, MOISSY-CRAMAYEL (FR); Didier LERETOUR, MOISSY-CRAMAYEL (FR)

(73) Assignee: SAFRAN NACELLES, GONFREVILLE-L'ORCHER (FR)

(21) Appl. No.: 18/840,276

(22) PCT Filed: Mar. 9, 2023
(86) PCT No.: PCT/FR2023/050318

§ 371 Date: Aug. 21, 2024

(30) Foreign Application Priority Data
Mar. 15, 2022 (FR) 2202242

(51) Int. Cl. B25J 15/00; B29D 24/00; B29L 31/60

(52) U.S. Cl. CPC B25J 15/0047; B25J 15/0023; B29D 24/005; B29L 2031/608

(57) ABSTRACT

A gripper for gripping a honeycomb-shaped part and depositing the part on a target surface includes gripping elements mounted on a support, each of the gripping elements being configured to be inserted into an internal cell of the honeycomb-shaped part. The gripping elements include a gripping surface that is laterally moveable relative to the support so as to come into contact with a side wall element of the internal cell.

### TECHNICAL FIELD

The invention relates to the gripping or manipulation of parts and, in particular, the gripping and depositing of parts on a target surface during the manufacture of composite parts.

More particularly, the invention relates to a gripper for gripping and depositing honeycomb-shaped parts on a target surface during the manufacture of composite parts.

### PRIOR ART

A gripper of an automatic pick-and-place machine conventionally consists of an effector mounted on a carrier which comprises, for example, a robotic arm, or which is controlled by a digital control device or a robot.

In the context of the production of composite parts, robots are already known in the prior art, comprising pneumatic grippers capable of grasping a patch by suction by creating a vacuum which enables the patch to press against the gripper until the gripper is positioned opposite the part on which the patch must be positioned. The patch is then pressed and lightly compacted against the part, the vacuum is stopped and the gripper withdrawn, leaving the patch on the target surface for the pick and place. The patch is, for example, an adhesive.

The robot is programmed so as to carry out successive phases of gripping of patches and depositing of the patches on a target surface.

Electrostatic or mechanical grippers are also known.

Although these techniques are advantageous for gripping and depositing patches of dry fibrous material, in other words not impregnated with resin, powdery, in other words having a particulate load, or pre-impregnated with resin, they cannot generally efficiently manipulate honeycomb-shaped parts, due to the presence of internal cells which, in particular, render gripping by suction ineffective.

### DISCLOSURE OF THE INVENTION

The aim of the invention is therefore to propose a gripper which is particularly suitable for gripping and depositing honeycomb-shaped parts on a target surface.

The object of the invention is therefore a gripper for gripping a honeycomb-shaped part and depositing the part on a target surface, comprising gripping elements mounted on a support and each intended to be inserted in an internal cell of the honeycomb-shaped part, said gripping elements comprising a gripping surface that is laterally displaceable relative to the support, so as to come into contact with a side wall element of the internal cell.

Thus, the gripping surface can be displaced laterally during the gripping phase until the phase of depositing the part, so as to hold the part by pressure of the gripping element against the wall element of the cell of the honeycomb-shaped part.

In an embodiment, the gripping elements include a set of laterally movable tips.

The gripping elements can also be movable relative to the support so as to adapt to the shape of the part.

In another embodiment, the gripper includes a set of tip-shaped gripping elements each provided with an internal passage opening out axially, and an inflatable bladder disposed in the internal passage and able to laterally deform, by inflating, outside of the tip.

According to yet another embodiment, the gripper includes a set of gripping elements, each comprising a pair of tips, articulated at one of their ends, and a control element acting on the pair of tips so as to move them apart laterally inside an internal cell of the part.

In another embodiment, the gripper can include a bladder that is deformable under the action of a differential pressure applied between the bladder and the honeycomb-shaped part, so as to push the bladder laterally against the wall element of internal cells of the part.

In various embodiments, the gripper can include a deformable material provided on a face of the support on which the gripping elements are mounted.

In an implementation, the gripping elements are mounted on plates that are axially displaceable relative to the support, between a first deployed position in which the gripping elements are positioned in the internal cells of the part, and a second retracted position in which the gripping elements are extracted from the internal cells of the part.

In another embodiment, the gripper comprises a release member of the part comprising a pusher acting on the honeycomb-shaped part so as to disengage the gripping elements from the internal cells of the part.

Another object of the invention is a robot for the gripping and depositing of honeycomb-shaped parts on a target surface, comprising a gripper as defined above.

### BRIEF DESCRIPTION OF THE DRAWINGS

Other aims, features and advantages of the invention will become apparent upon reading the following description, provided solely by way of non-limiting example, and with reference to the appended drawings in which:

FIG. 1 and

FIG. 2 show examples of honeycomb-shaped parts intended to be handled by means of a gripper according to the invention;

FIG. 3,

FIG. 4, and

FIG. 5 illustrate the kinetics of a robot during the gripping and depositing of a honeycomb-shaped part on a target surface;

FIG. 6a

FIG. 6b

and

FIG. 6c illustrate an example of a first embodiment or a gripper according to the invention;

FIG. 7 shows an example of distribution of gripping elements on the support of the gripper;

FIG. 8a

FIG. 8b

FIG. 8c

and

FIG. 8d illustrate a variant of the embodiment of FIGS. 6a, 6b and 6c;

FIG. 9a

FIG. 9b

and

FIG. 9c illustrate an example of a second embodiment of a gripper according to the invention;

FIG. 10a

and

FIG. 10b illustrate an example of a third embodiment of a gripper according to the invention;

FIG. 11a

FIG. 11b

and

FIG. 11c illustrate an example of a third embodiment of a gripper according to the invention:

FIG. 12 illustrates alternative embodiments of a gripper according to the invention; and

FIG. 13, FIG. 14, FIG. 15 and FIG. 16 illustrate another aspect of the gripper according to the invention.

### DETAILED DISCLOSURE OF AT LEAST ONE EMBODIMENT

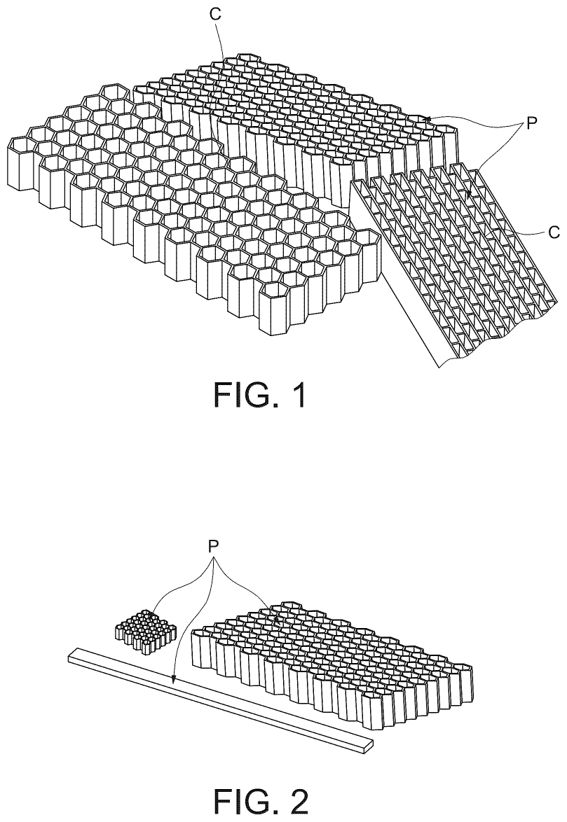

Reference is made primarily to FIGS. 1 and 2, which illustrate various forms of parts intended to be manipulated in order to produce composite material parts by means of a gripper according to the invention.

As represented, the parts P are produced as honeycomb and are capable of adopting various shapes, various formats, have different masses and include internal cells C having various shapes.

The gripper is thus capable of adapting to any type of internal cell, in particular hexagonal or trapezoidal types, whatever their dimensions, and to any type of part, whatever their format, geometry, mass or material.

In particular, the parts can, for example, measure less than 0.10 m on one side or, on the contrary, can measure up to 1 metre on a side, or be flat or bulky.

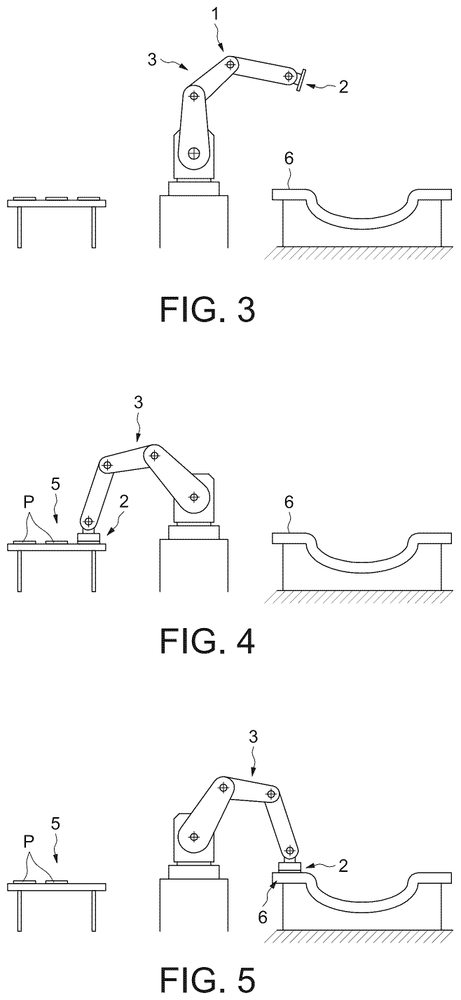

Referring to FIGS. 3, 4 and 5, such parts are manipulated by a robot 1 comprising a gripper 2 mounted at the end of a carrier 3, formed for example by a robot arm.

The robot is generally programmed to control the displacement and operation of the gripper in order that, during a first step illustrated in FIG. 4, it grasps a honeycomb-shaped part P by positioning device 5, for example, a supply table, a conveyor belt or a system of drawers, in order that during a second step, illustrated in FIG. 5, the carrier displaces the gripper to a target surface 6; and in order that, during a third step which is not shown, the carrier withdraws and the part P is detached from the gripper 2.

In various embodiments, the gripper includes gripping elements which are provided with a laterally displaceable gripping surface, so as to laterally engage with a wall element of a cell of the honeycomb.

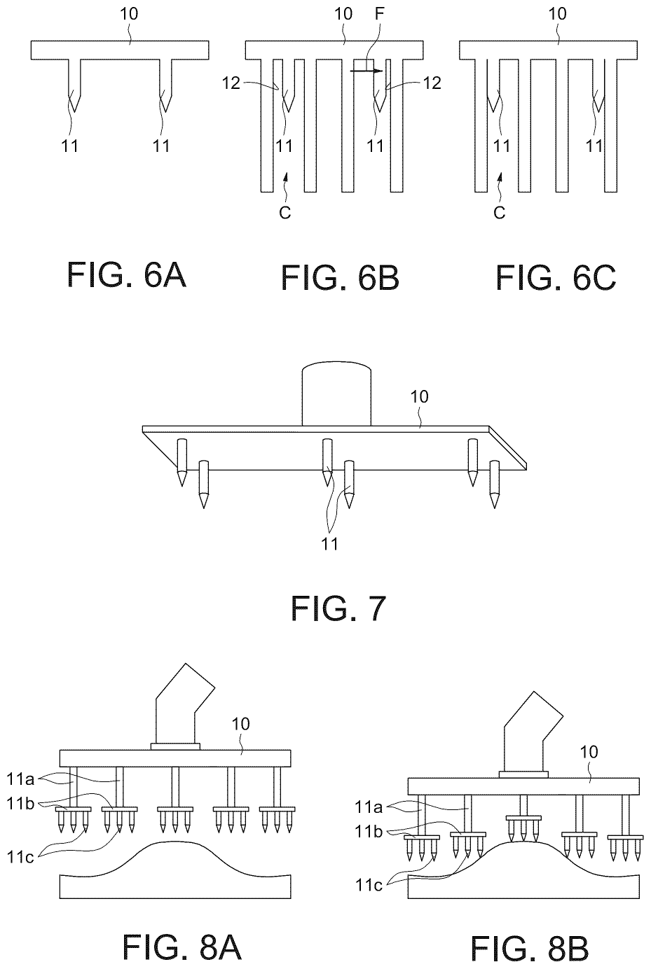

Referring primarily to FIGS. 6a, 6b and 6c, which schematically show a first embodiment of a gripper 2, in this embodiment the gripper includes a rigid support 10 and a set of tips such as 11 mounted on the support 10 and projecting from one of the faces of the support, intended to be applied against the honeycomb-shaped part.

The tips 11 are each intended to insert in a cell C of the part P. They have, for example, for this purpose, a round cross-section of appropriate dimensions in order to be able to insert in a cell, whatever its shape, in particular hexagonal or trapezoidal.

The tips 11 are mounted in a laterally movable manner, in other words in a direction parallel to the plane of the support 10 and include a gripping surface formed by the peripheral outer surface of the tips. 10

As illustrated in FIG. 6b and in FIG. 6c, the tips 11 can be displaced laterally (arrow F) until their peripheral surface comes into contact against an element 12 of the wall of a cell C, so as to apply a frictional force against this wall, sufficient to hold the honeycomb-shaped part P on the gripper and enable its gripping.

Preferably, the tips 11 are chosen so as to be shorter than the thickness of the honeycomb, so as to avoid then coming into contact with the target surface on which the honeycomb must be deposited, in order to avoid altering it.

As can be seen in FIG. 7, the support 10 can include any number of such tips, these tips being able to be distributed on the support according to the configuration of the part to be grasped.

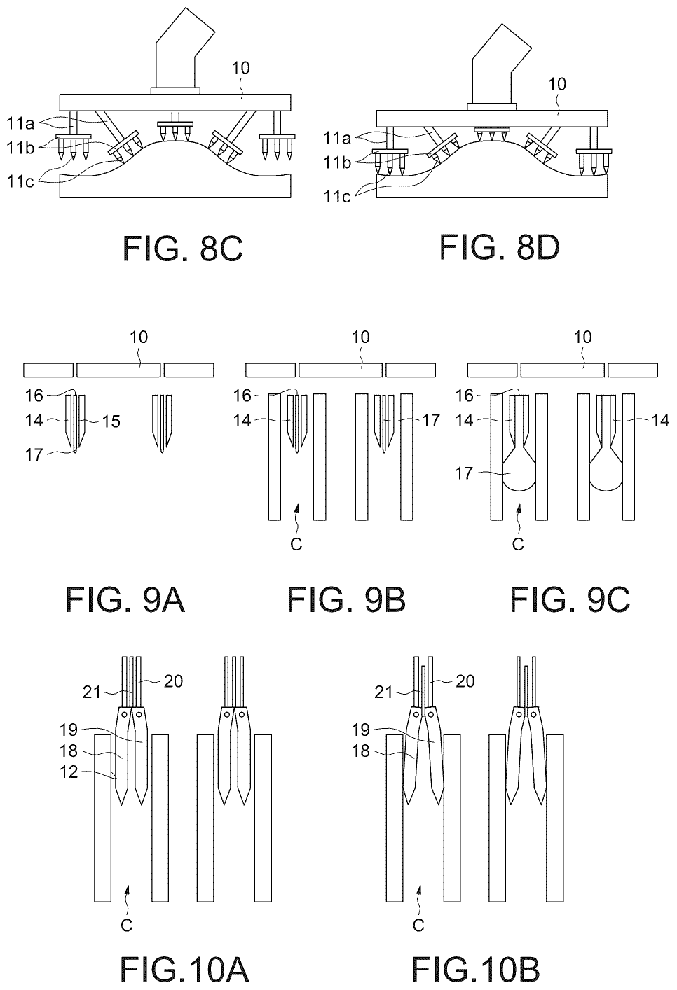

It should also be noted, with reference to FIGS. 8a, 8b, 8c and 8d, that the tips 11 can also be displaceable according to the shape of the part to be grasped. In other words, they can be locally retracted, elongated or oriented so as to adapt to the shape of the part to be grasped, in particular to the locally concave, convex or hollow shape of the part, or to adapt to the shape of the target surface.

As illustrated, the gripper can be equipped with a set of rods 11a, each provided with a cylinder and preferably provided with an articulation, at the end of which a gripping device is mounted, similar to the arrangement illustrated in FIG. 7 and comprising a support 11b on which the tips 11c are distributed.

With reference to FIGS. 9a, 9b and 9c, in another embodiment, the gripping elements are produced in the form of fixed hollow tips 14 mounted on the fixed support 10. These tips 14 are provided with an internal passage 15 opening via the free end of the tips and connected at the opposite end 16 to a pressurised air source (not shown), an inflatable bladder 17 which constitutes the gripping surface of the gripping elements being disposed in the internal passage and being connected to the pressurised air source.

In this embodiment, the inflatable bladders are inflated after insertion of the fixed tips 14 in the cells C of the honey comb and deform laterally outside of the hollow tip until they are pressed against the peripheral wall of the cells of the honeycomb (FIG. 9c). It should be noted that this embodiment can be combined with the embodiment previously described with reference to FIGS. 6a, 6b, 6c and 7, the tips 14 being able to be laterally displaceable in order to improve the pressing of the inflatable bladders against the peripheral surface of the cells of the honeycomb.

Furthermore, as in the previously described embodiment, the tips 14 have a cross-section with appropriate dimensions and shape for penetrating into the cells of the honeycomb. Their length is chosen so as to avoid them coming into contact with the target surface in order to avoid altering it.

According to a third embodiment, illustrated in FIGS. 10a and 10b, the gripping elements, which are also intended to be inserted into the cells of the honeycomb, each include, for each cell of the honeycomb, a pair of tips 18 and 19, each articulated on an axial rod 20 about an axis perpendicular to the general axis of the cells.

The tips 18 and 19 thus include a first free end, via which they are inserted into a cell of the honeycomb, and an opposite end via which they are articulated on the rod 20.

The gripping elements further include a control element 21 configured to exert a force on the tips 18 and 19 so as to move them apart against an element of the peripheral wall of the cells (FIG. 10b). As in the embodiment described previously with reference to FIGS. 6a to 6c, the gripping of the part is obtained by pressing the peripheral outer surface of the articulated tips against a wall element of the cells C.

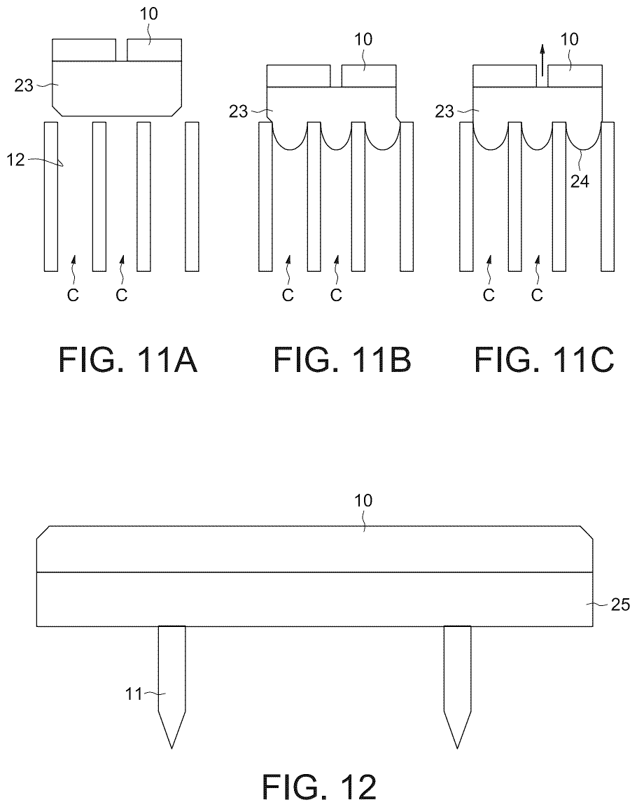

According to a fourth embodiment that can be seen in FIGS. 11a, 11b, and 11c, the gripping element includes a bladder 23 mounted on the support 10, this bladder comprising an active gripping surface 24 with respect to the part P that is deformable under the action of a differential pressure applied between the bladder and the cells of the honey comb.

Advantageously, the bladder is made of a sufficiently flexible material, for example silicone, in which it is possible to create a vacuum.

When the bladder is crushed on the honeycomb (FIG. 11b), a vacuum is created inside the bladder, for example by the Venturi effect, by the Coanda effect or by means of a vacuum pump, which causes pressing of the bladder on certain walls of the cell and therefore gripping of the honeycomb (FIG. 11c).

It will be noted that, in the various embodiments, and in particular in the first, second and fourth embodiments, in which the gripping elements are produced from tips, deformable bladders disposed in a hollow tip or a deformable bladder mounted on the support, a deformable material 25 (FIG. 12) can be provided on the face of the support from which the gripping elements extend, for example as a foam or silicone block, in order to improve the pressing of the honeycomb against the target surface, after the pressure applied on the gripping elements is released.

In the various embodiments described above, the honeycomb-shaped part P is held by the gripping elements which are laterally displaceable relative to the support so as to come into contact with a side wall element of an internal cell of the part.

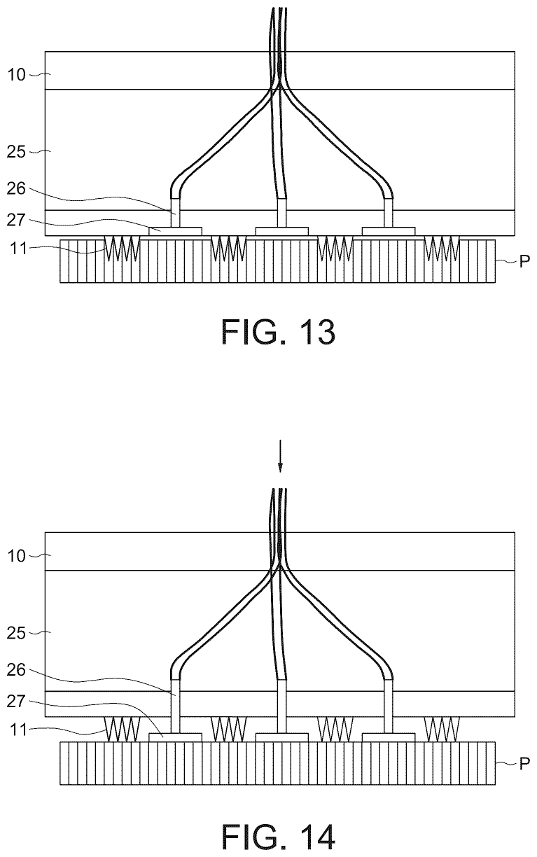

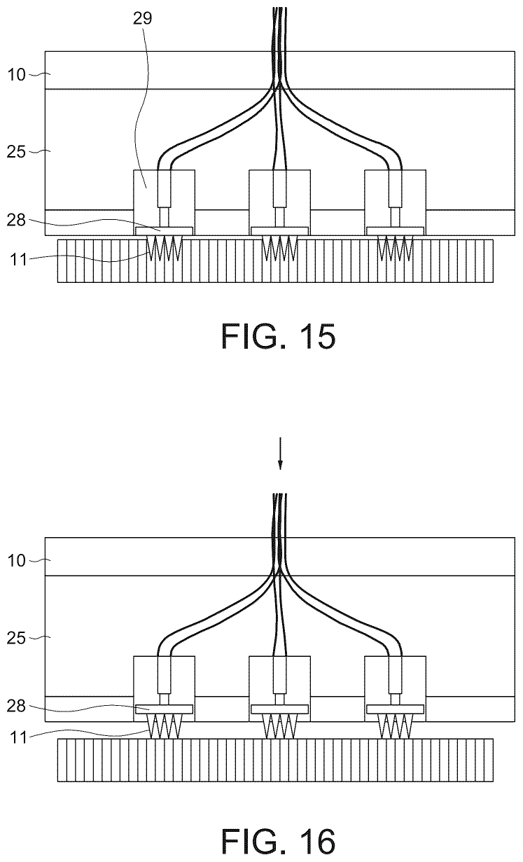

In other embodiments that can be seen in FIGS. 13 to 16, which can be used with the embodiments described above with reference to FIGS. 8a, 8b, 8c and 8d, to FIGS. 9a, 9b, and 9c, to FIGS. 10a and 10b and to FIGS. 11a, 11b, 11c and 12, the gripper can be equipped with means enabling the part to be released from the gripping elements.

Referring primarily to FIGS. 13 and 14, which correspond, by way of example, to the embodiment of FIG. 12, and on which the support 10 can be recognised, the deformable material 25 and the gripping elements, such as 11, the means acting to release the part from the gripping elements comprise a release member 26 separate from the gripping elements.

This member 26 has the shape of a pad provided with an end head 27 acting on the part P so as to disengage the gripping elements from the internal cells C.

This release member 26 is thus displaceable under the action of motor means, for example under the action of cylinders or of any type of pneumatic, hydraulic, electric or mechanical actuator, so as to exert a force on the part P, preferably after having replaced the gripping elements in an initial rest position in which they are disengaged from the side wall element of the cell.

In another embodiment that can be seen in FIGS. 15 and 16, the part P is released by retracting the gripping elements so as to disengage from the internal cells of the part.

In this embodiment, the gripping elements, such as 11, are grouped on support plates 28 in recesses 29 formed in the deforming material 25 under the actions of cylinders or any type of pneumatic, hydraulic, electrical or mechanical actuator.

Thus, the gripping elements can be disengaged from the cells after they have been repositioned in their rest position in which they are laterally disengaged from the wall element of each cell, so that they are extracted from the honeycomb-shaped part (FIG. 16).

1. A gripper for gripping a honeycomb-shaped part and depositing the part on a target surface, comprising gripping elements mounted on a support and each configured to be inserted in an internal cell of the honeycomb-shaped part, said gripping elements comprising a gripping surface that is laterally displaceable relative to the support so as to come into contact with a side wall element of the internal cell, a deformable material being provided on a face of the support on which the gripping elements are mounted.

2. The gripper according to claim 1, wherein the gripping elements include a set of laterally movable tips.

3. The gripper according to claim 1, wherein the gripping elements are movable relative to the support so as to adapt to the shape of the part.

4. The gripper according to claim 1, further comprising a set of tip-shaped gripping elements, each provided with an internal passage opening out axially, and an inflatable bladder disposed in the internal passage and able to laterally deform, by inflating, outside of the tip.

5. The gripper according to claim 1, further including a set of gripping elements, each comprising a pair of tips articulated at one of their ends, and a control element acting on the pair of tips so as to move the pair of tips apart laterally inside an internal cell of the part.

6. The gripper according to claim 1, further comprising a bladder that is deformable under the action of a differential pressure applied between the bladder and the honeycomb-shaped part, so as to push the bladder laterally against the wall element of internal cells of the part.

7. The gripper according to claim 1, wherein the gripping elements are mounted on plates that are axially displaceable relative to the support, between a first deployed position, in which the gripping elements are positioned in the internal cells of the part, and a second retracted position, in which the gripping elements are extracted from the internal cells of the part.

8. The gripper according to claim 1, further comprising a release member of the part comprising a pusher acting on the honeycomb-shaped part so as to disengage the gripping elements from the internal cells of the part.

9. A robot for gripping and depositing honeycomb-shaped parts on a target surface, the robot comprising the gripper according to claim 1.
